(19) United States
(12) Patent Application Publication
(10) Pub. No.: US 2017/0098988 A1
(43) Pub. Date: Apr. 6, 2017

(54) ELECTROMAGNETIC ACTUATOR WITH MOBILE MAGNET

(71) Applicant: F.Q.N.K, Melesse (FR)

(72) Inventor: Frédéric BARBET, Melesse (FR)

(73) Assignee: F.Q.N.K, Melesse (FR)

(21) Appl. No.: 15/380,539

(22) Filed: Dec. 15, 2016

Related U.S. Application Data
(63) Continuation of application No. 14/364,884, filed on Jun. 12, 2014, now abandoned.

(30) Foreign Application Priority Data
Dec. 16, 2011 (FR) 11/03883

(51) Int. Cl. H02K 33/16; F01L 9/04; H02K 7/14

(52) U.S. Cl. CPC H02K 33/16; H02K 7/14; F01L 9/04; F01L 2009/0448; F01L 2009/0469

(57) ABSTRACT

An electromagnetic actuator is provided in which a mobile member is designed to slide inside a ferromagnetic frame along a displacement axis X-X′ between two end positions, when exposed to a magnetic flux circulating in said frame. The frame forms a magnetic circuit that extends in a single loop interrupted by two air gaps, each placed on the displacement axis of the mobile member. At the air gaps the flux generates two transverse magnetic fields in opposite directions. The mobile member includes a permanent magnet, polarized in a pre-determined direction and having an axial dimension such that in each end position, one end of the magnet extends into one of the air gaps and the opposite end of the magnet extends into the other air gap.

This is a continuation Application of application Ser. No. 14/364,884 filed Jun. 12, 2014 which is a 371 of international Application No. PCT/IB2012/002719 filed Dec. 14, 2012, which claims priority to FR 11/03883 filed Dec. 16, 2011. The disclosures of the prior applications are hereby incorporated by reference herein in their entirety.

The invention relates to the field of actuators. More precisely, it relates to an electromagnetic actuator.

Electromagnetic actuators already exist in which a mobile member is designed to slide into a ferromagnetic frame. Creating a magnetic field in the frame by introducing a current into the coils in each frame module generates Laplace forces on a magnet that is solid with the mobile member, thus controlling its linear displacement.

This invention is aimed at offering an alternative to known constructions of electromagnetic actuators, by proposing an actuator in which a mobile member is designed to slide inside a ferromagnetic frame along a pre-determined displacement axis when exposed to a magnetic flux, and in which the frame is in the form of a single loop comprising two air gaps placed on the said displacement axis of the mobile member so that circulation of the magnetic flux through a single loop in the frame generates two magnetic fields in opposite directions, with each magnetic field extending into an air gap perpendicular to the pre-determined displacement axis. The mobile member comprises a permanent magnet, polarized in a pre-determined direction and having an axial dimension such that in each end position, the end of the magnet extends into one of the air gaps and the opposite end of the magnet extends into the other air gap.

Thus, according to the invention, the actuator enables the frame to be given a simple shape with a single magnet designed to be displaced entirely within the frame without having to move beyond the two air gaps formed by breaks in the circuit along the displacement axis in a magnetic circuit with a single loop. The result is an actuator with optimum energy efficiency, due to the simplicity and compactness of the flux path, such that the magnetic flux circulating in the frame loses only a small amount of energy before reaching the air gaps, and due to the use of a single polarized magnet driven by two magnetic fields in opposite directions, coming from the same magnetic flux.

In a preferred construction method of the invention, the frame comprises two U-shaped modules placed opposite each other and around the mobile member. Each module comprises a longitudinal wall extended at the ends by two transverse walls, with the end surfaces of the transverse walls located on the same longitudinal end of the frame, each opposite the other, thus forming an air gap between two transverse walls. This is a simple way of producing a frame that enables the air gaps to be arranged along the displacement axis as described above, in order to surround the permanent magnet and allow its linear displacement while ensuring that it remains constantly within the air gaps. This gives an open frame in which the mobile member can be easily mounted and which enables functional members to be easily connected to the mobile member.

According to a preferred characteristic of the invention, a position sensor is solid with the frame, to detect displacement of the mobile member. This detection can be advantageously used to adjust the magnetic flux generated by the frame. The sensor could be placed on one end of the mobile member, at the actuator output end, or inside the module. Once again, the open shape of the frame means that the sensor can be easily placed inside the module in a suitable position for measuring the displacement.

According to the invention, the magnetic flux is generated by several coils placed respectively around one of the walls of the frame and driven electrically so that each coil generates a similar magnetic flux, which circulates in a single loop in the frame.

Thus, any number of coils can be driven without changing the path of the magnetic flux created by the current. Fluxes can be added and concentrated along the same path, in a single loop, which increases the efficiency of the actuator.

According to a preferred characteristic of the invention, the end positions of the mobile member are determined by mechanical axial stops, so as to create stable rest positions for the mobile member when the coils are not driven electrically. Since the magnetic fields created in the air gaps, between which the magnet is placed, are in opposite directions, the repulsive forces of one of the fields on the magnet and the attractive forces of the other field of the magnet combine to push the mobile magnet towards the end of the mobile member and against the axial stops. The magnet is thus locked into a pre-determined position, in which the ends of the magnet are kept within their respective air gaps, so that the magnet is ready to be displaced in the opposite direction if the current in the coils is reversed.

According to some particularly advantageous characteristics of the invention, the mobile member can comprise a magnetic part added to the mobile member at a distance from the permanent magnet, so that the said magnetic part extends outside the frame regardless of the position of the mobile member, from one end position to the other. In one particular construction method, the said magnetic part has a transverse dimension that is greater than that of the air gaps, in order to form a mechanical axial stop for the mobile member.

According to an advantageous characteristic of the invention, the actuator comprises means to make the rest positions asymmetrical and give preference to one rest position rather than another. Mechanical means with springs could be provided, for example, to return the mobile member to its initial position, or magnetic means which could be advantageously formed by a magnetic part such as that described above. It is understood that it is possible to combine them, especially to ensure safe operation of the actuator.

In the case of specific application of the actuator to a combustion engine, the mobile member is connected to a valve stem. Advantageously, the preferred rest position of the actuator as described above is made to correspond to the closed position of the valve. In the case of a faulty power supply, this would prevent the valve remaining open and causing the piston to strike the valve.

Other characteristics and advantages of the invention will become more apparent during the following description illustrated by the figures below:

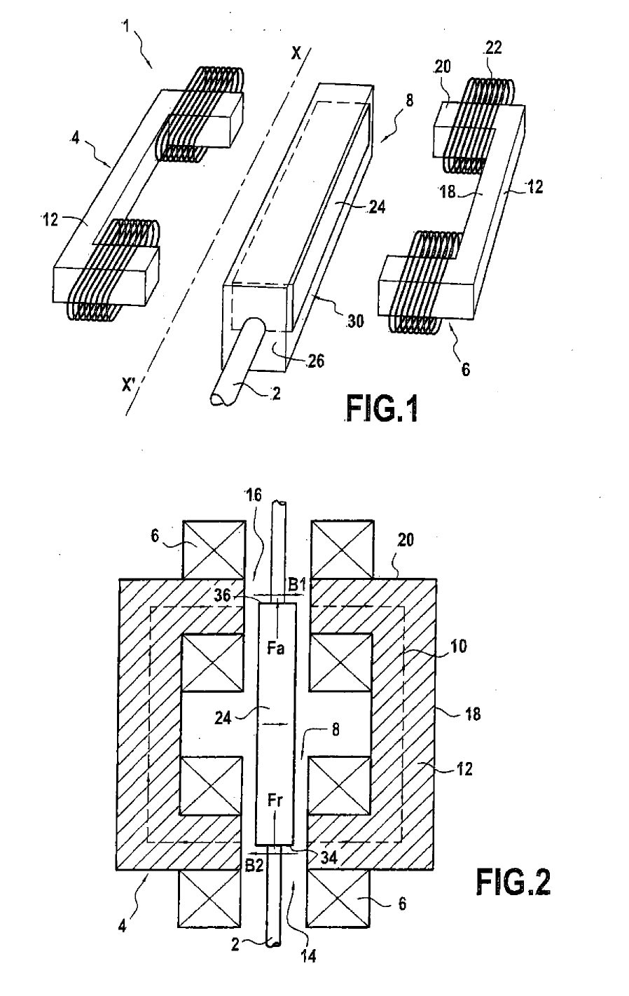

FIG. 1, which is an exploded bird's eye view of an electromagnetic actuator according to a first construction method of the invention, with four coils mounted on two modules of a ferromagnetic frame between which a mobile member supporting a single magnet in a cage is able to slide;

FIGS. 2 and 3 which are cross-sections in the horizontal plane of the actuator in FIG. 1, in which the cage is not depicted for reasons of clarity and showing both the circulation in the frame of the magnetic flux created by the coils when driven electrically, in one direction or the other, and the attractive and repulsive forces exerted on the magnet;

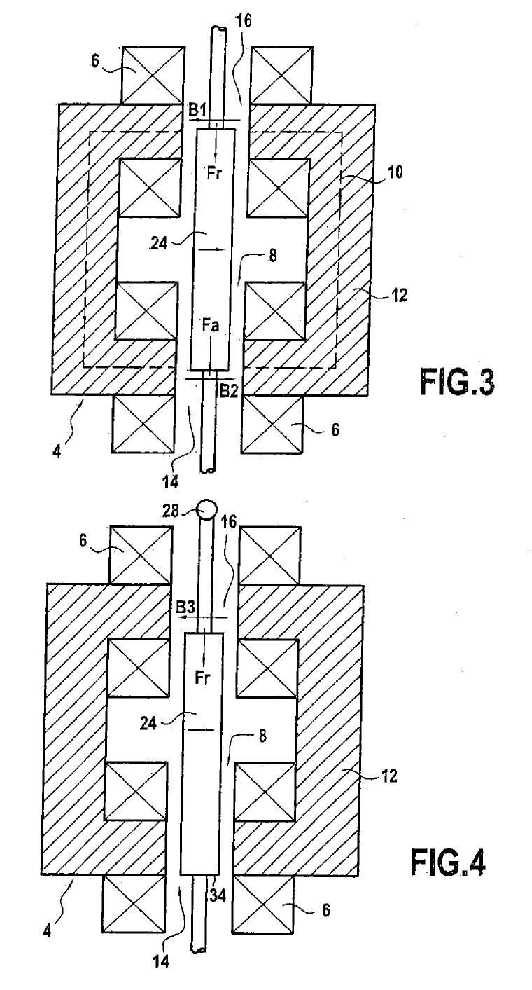

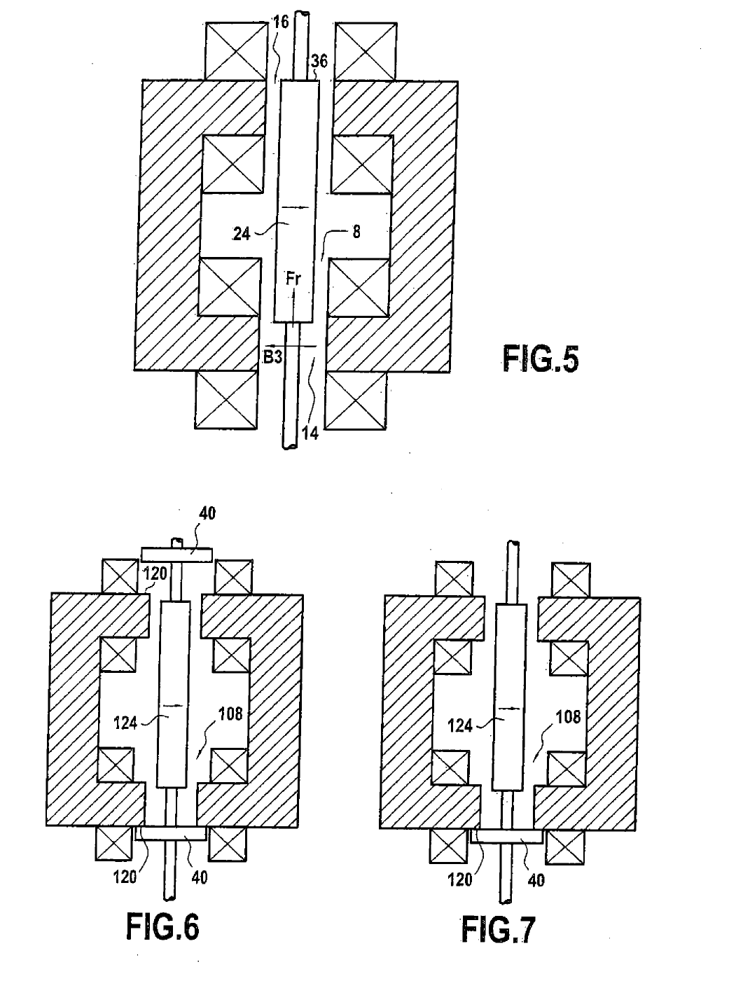

FIGS. 4 and 5, which show the actuator in a similar view to that of FIGS. 2 and 3, in a rest position that is respectively proximal and distal, when the coils are no longer driven electrically;

and FIGS. 6 and 7, which show an actuator according to a second method of construction of the invention, in a similar view to that of FIGS. 2 and 3, with respectively one and two magnetic parts added to the mobile member.

A linear electromagnetic actuator 1 of the invention will now be described in its application to driving a combustion engine valve stem 2. It will be understood that, without going outside the context of the invention, the actuator could be connected to a part other than a valve and have the same operating advantages.

The valve and the mobile member are designed to move along an axis X-X′, as shown on the figures.

Here, the displacement of the mobile member controls the displacement of the valve between a closed position in which the valve makes the combustion chamber of the engine airtight, and an open position in which the clearance of the valve head is at its maximum to allow communication between an inlet or exhaust pipe and the combustion chamber.

As illustrated in FIG. 1, an actuator 1 comprises a frame 4 which supports electromagnetic coils 6 and a mobile member 8 designed to move linearly inside the frame along a displacement axis X-X′, when exposed to a magnetic flux 10 generated in the frame.

The frame is formed by two U-shaped modules 12 placed opposite each other to form a magnetic circuit comprising two air gaps 14, 16. The air gap facing the valve and any other part to be actuated will be called the proximal air gap 14 and the air gap opposite the valve will be called the distal air gap 16.

Each U-shaped module has a longitudinal wall 18 which extends along the X-X′ axis and is extended transversally at each end by means of a transverse wall 20.

The frame is mounted with the modules opposite each other around the mobile member. Since the frame is open, it can also be mounted by fixing the modules into position then subsequently inserting the mobile member between the modules. Once it is mounted, the frame comprises two parallel longitudinal walls and the two modules are placed opposite each other so that the transverse walls are facing each other, two at a time, while leaving a passage at each longitudinal end of the frame to form an air gap.

A hood (not shown in the figures) can be provided advantageously to cover the actuator and protect the parts of the coils outside the frame and thus prevent the electromagnetic flux from being dispersed outside the frame when the coils are driven electrically.

Frame 4 is made of a ferromagnetic material. It supports four electromagnetic coils 6 mounted respectively around part of the magnetic circuit in order to create a magnetic flux in the frame. The coils consist of electromagnetic turns 22. As illustrated, they are placed respectively around a transverse wall and each of the coils partly rests against one of the longitudinal walls of the frame, ensuring that the coils are positioned by abutment and facilitating cooling.

The axis of the coils is approximately parallel to the transverse walls and is orthogonal to the axis of displacement X-X′. The arrangement of the coils around the transverse walls enables the thickness of the actuator in the transverse direction to be reduced.

The coils comprise an electrical power supply (not depicted) connected to a control circuit (not depicted). One or several control circuits can be used to drive the coils electrically. Advantageously, a control circuit can be provided for each coil or a single control circuit can be used to drive all the coils in series and/or in parallel, in a less expensive actuator, for example. In this second case, it can be observed that several connection layouts are possible without going outside the invention and parallel and/or series mounting of the coils does not change the operating principle of the single flux loop actuator but enables the amount of current to be dimensioned.

The shape of the frame, that is, the shape of the modules comprising the frame, means that when the coils are electrically powered, the magnetic flux 10 (visible on FIGS. 2 and 3) is generated such that it follows the path of a single loop which flows successively through all the walls of a module 12, from the proximal air gap 14 to the distal air gap 16, then successively through all the walls of the other module, this time from the distal air gap to the proximal air gap, before returning to its point of departure, creating magnetic fields in all the air gaps through which it passes from one module to the other, with said magnetic fields being transverse to the axis of displacement X-X′. It can be seen in FIGS. 2 and 3 that a magnetic field B₁ exists in distal air gap 16 and a magnetic field B₂ in proximal air gap 14.

Advantageously, whatever the initial position of the flux, that is, whatever the position of the electrically powered coil, the single loop pathway of the flux remains the same and the transverse direction of the magnetic fields remains the same. The direction of the flux and magnetic fields in the air gaps depends on whether the power supply in the coils is negative or positive. If they are both the same, it can be observed that the flux path is the same regardless of which coil it starts with. As a result, if the power supply has the same sign (positive or negative), the flux path remains the same, whether there are four coils powered simultaneously or a single coil.

In this case, a single coil can be used for less intensity and the others coils powered depending on the rapidity of the response required of the actuator.

The fact that the flux is identical regardless of which coil is powered means that operating safety can be proposed so that the device can operate with a single coil, by dimensioning each coil accordingly. The device can thus operate with one coil if any of the other coils fail, until they can be replaced.

The mobile member is designed to be displaced linearly, when exposed to the magnetic fields described above, between a distal end position (visible on FIG. 5) which corresponds to the closed valve position in the present application of the actuator, and a proximal end position (visible on FIG. 4), which corresponds to the open valve position. The displacement of the mobile member and the associated valve stem can be guided by axial guides not depicted here.

The mobile member 8 comprises a permanent magnet 24 housed in a cage 26 which surrounds the magnet. The valve stem 2 is screwed into one end of the mobile member so that the valve has the same axial displacement as the mobile member. At the opposite end, a position sensor 28 is mounted (as can be seen in FIG. 4), by Hall effect, for example, designed to cooperate with housing not depicted here and which covers the end of the mobile member extending beyond the frame. In a variant, the position sensor could be incorporated into the modules between the coils to avoid the extra space required by additional housing. In this case, it should be located in a neutral area so that there is no variation in the magnetic field. The arrangement of the actuator according to the invention, in which the magnetic flux flows in a single loop, on the periphery of the frame only, enables this neutral area to be generated between the coils, in the trough of the U-shaped modules.

The cage, visible on FIG. 1, has a mainly parallelepipedic shape, whose transverse dimension is slightly less than the transverse thickness of the air gap, that is, the distance between the transverse walls opposite the frame modules, to enable linear displacement of the mobile member without causing friction with the transverse walls. The cage could be produced by overmoulding on the permanent magnet, it being understood, as described below, that the permanent magnet 24 comes out on the transverse sides of cage 30. The cage is made of a material that is not magnetically conductive, such as aluminium.

The permanent magnet is polarized along a transverse direction approximately parallel to the magnetic fields B₁ and B₂ present in the air gaps respectively. The said magnet has the same thickness as the cage such that, in the said transverse direction, it is not covered by the cage and that it comes out on both sides, opposite each of the transverse walls forming the air gap.

The permanent air gap has a longitudinal dimension along the axis of displacement X-X′, approximately equal to the distance between the center of the distal air gap 16 and the center of the proximal air gap 14. Similarly, when the permanent magnet is positioned in the frame, an axial stop can be used so that each end of the magnet is always in its correct position in the corresponding air gap and the magnetic fields generate both a repulsive force Fᵣ and an attractive force Fₐ on the magnet.

In the distal end position, illustrated in FIG. 5, an axial stop is used so that the distal end of the magnet 36 will not extend beyond the distal air gap 16 outside the frame and that the proximal end of the magnet 34 will not extend beyond the proximal air gap 14, inside the U-shaped modules. For safety purposes, it could even be arranged so that, in the end position, the ends of the magnets are not flush with the walls of the modules but slightly behind them, in the air gaps. And it will be understood that equivalent means can be provided to ensure the correct position of the magnet in the proximal end position.

The permanent magnet, and subsequently the valve stem, can move linearly along the axis of displacement X-X′, when exposed to magnetic fields B₁ and B₂. It is understood that the permanent magnet is subjected to an electromagnetic Laplace force along a direction which is transverse to the X-X′ axis and that, to determine the direction of displacement of the permanent magnet, the direction to be given to the electromagnetic force must take into account both the direction of the magnetic field generated by the magnet and the direction of the magnetic fields created by the coils between the air gaps. Here, the direction of the permanent magnet is fixed and it is the direction of the current circulating in the coils which is variable. As illustrated in FIGS. 2 to 6, in this construction method, a permanent magnet has been chosen which is polarised from left to right. The control circuits associated with the coils are what enable the direction of the currents in the coils to be changed and subsequently the direction of the magnetic fields in the air gaps, which also enables the direction of the repulsive forces and attractive forces exerted on the permanent magnet to be changed.

We are now going to describe how the actuator is used.

When the coils are supplied with electrical power, a magnetic field B₁ is present in the distal air gap and a magnetic field B₂ in the proximal air gap. As described previously, since a single loop of flux is formed according to the invention, the two magnetic fields are in opposite directions. In the following description, as illustrated in FIG. 2, the control circuits generate a direction of current such that the direction of the magnetic field B1 in the distal air gap is the same as that of the permanent magnet and the direction of magnetic field B2 in the proximal air gap is the same as that of the permanent magnet. The magnet is then attracted to the field which has the same direction, as shown in the figure by the representation of the attractive forces Fa, while the magnetic field having the opposite direction to the polarisation of the magnet repels the magnet as shown in the figure by the representation of the repulsive forces Fr.

The mobile member 8 and valve stem 2 are thus displaced linearly along the axis X-X′ following the movement of the permanent magnet 24. It is understood here that the axial displacement of the mobile member towards proximal air gap 14 causes the valve to open while its displacement towards distal air gap 16 causes it to close.

The shape of the actuator, in which the mobile member is designed to move between the two air gaps through which the same magnetic flux passes in the opposite direction, ensures that the repulsive forced with respect to one magnetic force and the attractive force with respect to the other magnet force are combined in the same direction to participate in rapid, responsive displacement of the mobile member, which ensures efficiency of the actuator.

The direction of linear displacement of the mobile member is controlled according to the direction of the current. It is understood that by inversing the current in the coils, the force and therefore the direction of displacement of the mobile member, is reversed. In the case in which each coil has its own control circuit, the direction of the current sent through each of the coils can be changed to influence the intensity of the magnetic flux and therefore the rapidity of displacement of the mobile member.

The magnitude of the repulsive and attractive forces and the axial displacement of the mobile member along the axis of displacement X-X′, in one direction or the other, depend on the intensity of the electric current in the coils.

The displacement of the mobile member in translation is thus created as soon as the current is introduced into the coils. More precisely, the direction of displacement of the permanent magnet and the speed of the said displacement are managed by controlling the direction and intensity of the current in the coils.

For a given value of current intensity in the coils, the mobile member reaches a given axial position of equilibrium, between the distal end position and the proximal end position. The actuator according to the invention then allows variable raising of the valve by controlling the current intensity of the coils to achieve variable displacement of the permanent magnet between two end positions.

According to the invention, there are two end positions, at the distal air gap and the proximal air gap respectively which are reached according to the direction given to the current in the coils.

It is particularly advantageous to be able to maintain these end positions at rest, that is, when the current is cut off and no longer circulating in the coils.

The rest positions of the mobile member are shown in FIGS. 4 and 5. In the absence of an electrical current in the coils, and therefore in the absence of a magnetic field in the air gaps, the permanent magnet tends to move along the X-X′ axis to axially take up a central position in the distal or proximal air gap according to the position occupied by the magnet when the current was cut off. If the magnet is close to the distal air gap, it will tend to lodge in the distal air gap, whereas if the magnet is close to the proximal air gap, it will tend to lodge in the proximal air gap.

The magnetic flux created by the magnet tries to form a closed loop. When the magnet is lodged in one of the air gaps, the circuit formed by the electromagnetic frame enables the magnetic flux to form a loop by flowing through the electromagnetic frame rather than the air, and thus minimize dispersion of the magnetic flux.

The rest position of the mobile member is determined magnetically by the attraction of the magnet in the air gap and mechanically by the axial stops, for example, by the valve stop which, in its closed position, rests on its seat in the cylinder head. It will be understood that the different axial stops that can be envisaged, whether they are in contact with the cylinder head stem or the cage of the mobile member, have not been depicted.

In the said rest position, the permanent magnet tries to take up a central position in the closest air gap and the axial stops prevent it from taking up the said central position and remaining in the end position, without going beyond the air gap so that the opposite end of the magnet remains in the other air gap at the same time.

The position is made stable by each additional magnetic field B3 (visible in FIGS. 4 and 5) which is created in the air gap in which the magnet is not lodged. It is understood that the direction of the additional field is the reverse of that of polarisation of the magnet, due to the U-shape of the modules forming the frame and closed loop circulation of the field created by the magnet, and that a repulsive force is thus created that is added to the force of the magnet causing it to take up a central position in the air gap, so that the added forces push the mobile magnet up against the axial stops.

Two particularly stable and symmetrical rest positions can thus be obtained according to the invention.

We are now going to describe a second construction method illustrated in FIG. 6, in which the frame and coils remain unchanged with respect to the construction method previously described, and in which, once again, mobile member 108 has a permanent magnet 124 housed preferably in a cage (not depicted here but approximately the same as the cage shown in FIG. 1).

In this second construction method, additional magnetic parts 40 are placed on either side of the mobile member, at a certain distance from the permanent magnet. The additional parts can be fixed to or placed at a distance from the cage or they can be embedded in the cage, provided they are placed at a pre-determined distance from the magnet on the axis of displacement.

Whatever their position on the axis with respect to the magnet, each of the magnetic parts must be placed outside the frame, with a proximal magnetic part and a distal magnetic part, associated with the proximal air gap and distal air gap respectively, while the magnet is inside the frame, between the air gaps.

Thus, when the coils are electrically powered, as described in the first construction method, the magnet tends to position itself in one of the air gaps depending on the direction of the current and therefore the magnetic flux. This linear displacement of the magnet tends to repel a magnetic part away from the corresponding air gap and to attract the other part to the corresponding air gap. One of the magnets then comes close to the transverse walls of the frame as shown in FIG. 6 with the proximal magnetic part in proximity to the walls of the frame while the magnet is positioned in the distal air gap.

These magnetic parts are thus particularly useful, each in turn, when the coils are supplied with electricity in one direction and then the other, on the one hand because the alternate attraction of the magnetic parts to the frame provides an additional force to maintain the alternate end positions of the magnet in the corresponding air gap and on the other hand because they can enable the required current to be reduced to obtain the end position, by accompanying the movement of the mobile member.

These magnetic parts are also useful when the coils are no longer electrically powered, since they encourage displacement of the magnet towards one of the rest positions, that is, the rest position to which the magnet is closest when the electricity is cut off as described previously, and because they create a force that tends to push the permanent magnet as far as it can go when it is in its end position, thus ensuring a stable position at rest.

It will be understood that the magnetic parts are dimensioned to ensure that they will be attracted by the frame, without interfering with the attraction and repulsion of the magnet with respect to the air gaps as described previously in the first construction method.

The additional parts also mean that the dispersion of the radiation of the coils into the air can be reduced by screening the magnetic field on the side of the frame on which they are positioned. The magnetic field can thus be concentrated more intensely in the magnetic circuit and, by extension, on the magnet.

In the case (shown in FIG. 6) in which the additional parts are not mounted in the cage but directly on the valve stems made solid with the magnet, for example, the additional parts can also be used as an axial stop when their transverse dimension is greater than that of the corresponding air gap, so as to come up against the transverse walls 120 of the frame.

Within the framework of the application to a combustion engine valve described previously, it is particularly advantageous to give preference to one rest position rather than the other, so that the single rest position corresponds, for example, to the closed position of the valve, in order to prevent one of the engine pistons, during its cycle, from striking the corresponding valve which has remained open and projects into the combustion chamber. As described previously, it is the distal end position that corresponds here to the closed position of the valve and in this particular construction method of the invention, illustrated in FIG. 7, a preferred rest position is sought in which the permanent magnet always remains within the distal air gap, regardless of the position of the magnet when the current supply is cut off. It will be understood that the search for a preferred rest position could also be advantageous in other applications of the actuator according to the invention.

In this case, means must be provided to make the rest positions dissymmetrical so that one can be preferred to the other. The said means can be mechanical or magnetic. We will now describe the magnetic means formed by an additional magnetic part such as that presented above in the second construction method. Mechanical means could be substituted or added, such as the addition of a return spring.

As seen previously, the additional part is positioned to keep the magnet at a pre-determined distance, such that, when the magnet is in the end position, attracted by the distal air gap, the additional part is located outside the actuator, on the other side, along the X-X′ axis of the proximal air gap.

Whatever the position of the mobile member, cutting off the electricity supplied to the coils automatically returns the mobile member to its preferred rest position, with the permanent magnet tending to return to the distal air gap where there is no longer a magnetic field, and being pushed towards the distal air gap rather than towards the proximal air gap by the attraction of the additional part to the transverse walls delimiting the proximal air gap of the frame.

Once again, the use of the said magnetic part has advantages relating to the additional force which ensures a stable end position, a reduction in the current to be provided to obtain the end position, screening of the magnetic field and the formation of an axial stop.

It will be understood here that preference has been given to a rest position that corresponds to the closed position of the valve, but that the simplicity of the actuator design according to the invention enables one rest position to be preferred to the other on demand. The magnetic part simply needs to be placed on the mobile member, beyond the distal air gap, for the preferred rest position of the permanent magnet to be in the proximal air gap.

In the case in which a single magnetic part is added, it will be understood that it could be arranged as depicted in FIG. 7, between the magnet and the member to be activated, in this case a valve, such that the proximal air gap separates the magnet from the additional part, or, in a mirror operation, it could also be placed so that it is the distal air gap that separates the magnet from the additional part, with the latter always being positioned outside the frame. We are now going to describe how the layout illustrated in FIG. 7 works and it will be understood that it is the same if the magnetic part is placed on the other side of the frame.

The description above clearly explains how the invention is able to achieve its objectives. In particular, the actuator according to the invention has a simple, light design, with U-shaped modules placed opposite each other. This offers many mounting possibilities: the coils can be mounted on the ferromagnetic frame at the same time as the cage is mounted with the valve stem. The frame is easily assembled around the frame without having to drill holes in the walls of the frame to allow the valve stem to pass through. As a result, the advantageous layout of the invention can be easily created in which a permanent magnet is designed to move between two air gaps formed in the frame and in which magnetic fields of opposite directions are created, thanks to the loop-shaped flux pathway due to the U-shape of the modules.

The fact that the actuator has a single magnetic flux loop which remains the same regardless of which coil is electrically powered means that the same flux pathway can be kept regardless of which coils are electrically powered. It is easy to replace a coil without interfering with the operation of the actuator. A magnetic field of the required intensity is obtained by varying the number of coils electrically powered without changing the pathway of the flux generated. Advantageously, the said pathway is simple, forming a loop, and short. There is no significant loss of energy along the pathway which means that the magnetic fields in the air gap are strong. The actuator is then very efficient and almost all the electrical energy used to power the coils is used to displace the mobile magnet by the repulsion or attraction of the magnetic fields.

Furthermore, having a single magnet reduces the risk of incorrect polarisation during mounting, which is particularly important when programming actuators, especially in the case of application to valve displacement, as described previously where one rest position is preferred to the other.

A different number and arrangement of coils could be used with, for example, two coils placed axially around longitudinal walls, if there is more space to lodge the actuator, it being understood that in this variant, a single flux loop is also formed with two air gaps between which a permanent magnet is designed to move linearly.

In a variant not depicted, the actuator could have a cylindrical shape obtained using the frame and mobile member illustrated in FIG. 1. The two modules and the permanent magnet are rotated around an axis parallel to the axis of displacement and placed outside the frame. This gives a cylindrical actuator with, from its centre to its periphery, an interior cylindrical module, a cylindrical magnet with an annular section and an exterior cylindrical module. A coil can be lodged in the centre of the actuator and generate a magnetic flux in a single loop between the two coaxial modules. The permanent magnet stays in place, in accordance with the teachings of the invention, axially between the two air gaps.

In a variant not depicted, the actuator could enable the mobile member to move along a curved axis of displacement. To achieve this, the actuator has a mobile member which has the same radius of curvature as that of the axis of displacement. Where necessary, depending on the place in which the curved axis is placed, the frame could have curved air gaps so that the magnet does not strike the walls delimiting the air gaps during its displacement. As described previously, this variant also has the advantage of a magnetic flux passing through a single loop and a permanent magnet placed inside the frame between two air gaps on the magnetic circuit followed by the flux.

However, the invention is not limited to the embodiments specifically described in this document and extends, in particular, to all equivalent means and any technically feasible combination of these means. In particular, the actuator could be constructed so as to be incorporated into an existing system using existing parts to provide the functions of the magnetic frame and magnetized mobile member. For example, the frame could be constructed by an appropriately shaped cylinder head and a magnetized part incorporated in the valve stem to form the mobile member.

1. Electromagnetic actuator in which a mobile member is designed to slide inside a ferromagnetic frame along a displacement axis X-X′ between two end positions when exposed to a magnetic flux circulating in said frame,
wherein the said frame forms a magnetic circuit with a single loop interrupted by two air gaps each arranged on the said axis of displacement of the mobile member, so that the magnetic flux circulates in a single loop in the frame so that two magnetic fields of opposite direction are generated in the air gaps, with each magnetic field extending transversely to the said pre-determined axis of displacement,
and wherein the mobile member comprises a permanent magnet, polarized in a pre-determined direction and having an axial dimension such that in each end position, one end of the magnet extends into but not beyond one of the air gaps and the opposite end of the magnet extends into but not beyond the other air gap.

2. Actuator according to claim 1, wherein the frame comprises two U-shaped modules placed opposite each other and around the mobile member, each module comprising a longitudinal wall extended at the ends by transverse walls, with the end surfaces of the transverse walls located on the same longitudinal end of the frame, each opposite the other, thus forming the air gaps.

3. Actuator according to claim 1, wherein a position sensor fixed to the frame detects displacement of the mobile member.

4. Actuator according to claim 1, wherein the magnetic flux is generated by several coils placed respectively around one of the walls of the frame and driven electrically so that each coil generates a similar magnetic flux, which circulates in a single loop in the frame.

5. Actuator according to claim 4, wherein the said end positions of the mobile member are determined by mechanical axial stops, so as to create stable rest positions for the mobile member when the coils are no longer driven electrically, with the repulsive forces of one of the fields of the magnet and the attractive forces of the other field of the same magnet combining to push the magnet and the mobile member up against the said axial stops.

6. Actuator according to claim 1, wherein the mobile member comprises a magnetic part added to the mobile member at a distance from the permanent magnet, so that the said magnetic part extends outside the frame regardless of the position of the mobile member, from one end position to the other.

7. Actuator according to claim 6, wherein the transverse dimension of the said additional magnetic part is greater than that of the air gaps so as to form a mechanical stop for the mobile member.

8. Actuator according to claim 1, further comprising means to make the rest positions asymmetrical and give preference to one rest position rather than another.

9. Actuator according to claim 6, wherein the mobile member is connected to a combustion engine valve stem, with the preferred rest position corresponding to the closed position of the valve.

10. Electromagnetic actuator in which a mobile member is designed to slide inside a ferromagnetic frame along a displacement axis X-X′ between two end positions when exposed to a magnetic flux circulating in said frame, the mobile member being mounted on a valve stem,
wherein the said frame forms a magnetic circuit with a single loop interrupted by two air gaps each arranged on the said axis of displacement of the mobile member, so that the magnetic flux circulates in a single loop in the frame so that two magnetic fields of opposite direction are generated in the air gaps, with each magnetic field extending transversely to the said pre-determined axis of displacement,
wherein that the mobile member comprises a permanent magnet, polarized in a pre-determined direction and having an axial dimension such that in each end position, one end of the magnet extends into one of the air gaps and the opposite end of the magnet extends into the other air gap,
wherein the valve stem extends beyond both ends of the magnet, and at least one mechanical stop is mounted on the valve stem outside of the frame, the mechanical stop configured to keep the valve stem quiet when the electromagnetic actuator is not in use.
